(19) United States
(12) Patent Application Publication
(10) Pub. No.: US 2011/0099826 A1
(43) Pub. Date: May 5, 2011

(54) MOUNTING AID FOR INSTALLING CURTAIN ROD BRACKETS

(75) Inventor: Ju-Huai Chen, Changhua County (TW)

(73) Assignee: MY HOME GLOBAL COMPANY, Changhua County (TW)

(21) Appl. No.: 12/611,721

(22) Filed: Nov. 3, 2009

(51) Int. Cl. B25H 7/00

(52) U.S. Cl. 33/666

(57) ABSTRACT

A mounting aid for installing curtain rod brackets includes a main body is at two opposite ends with correspondingly arranged marking holes. With the mounting aid, a user can easily utilize the marking holes to put marks on a wall at desired positions for fixing curtain rod brackets, allowing quick execution of subsequent steps of fixing brackets and assembling the curtain rod to complete the installation of a curtain at reduced labor and time cost.

### FIELD OF THE INVENTION

The present invention relates to a mounting aid for installing curtain rod brackets, and more particularly to a mounting aid that allows a user to easily put marks on a wall at positions desired for fixing curtain rod brackets to complete the installation of a curtain at reduced labor and time cost.

### BACKGROUND OF THE INVENTION

Conventionally, before installing a curtain, a level and a tape measure are needed to measure, determine, and put marks at positions desired for fixing curtain rod brackets on a wall. After the marks are made, the curtain rod brackets are aligned with and then screwed to the marked positions, and then, a curtain rod is assembled to and between the fixed brackets to complete the installation of the curtain.

To correctly put the marks on the wall, a user has to measure the length and width of the curtain rod first, and then uses the level and tape measure to draw horizontal lines and vertical lines on the wall according to the length and width of the curtain, so that a mark can be put at each of the intersections of the horizontal and vertical lines to indicate the desired position for fixing the curtain rod brackets. The steps of marking the bracket fixing positions before installing the curtain are complicate and inconvenient to the user. In addition, the above steps oftentimes still result in asymmetrical and error marks.

It is therefore desirable and tried by the inventor to develop a mounting aid that allows a user to easily put marks on a wall at positions desired for fixing curtain rod brackets to quickly complete the installation of a curtain at reduced labor and time cost.

### SUMMARY OF THE INVENTION

A primary object of the present invention is to provide a mounting aid for installing curtain rod brackets that allows a user to easily put marks on a wall at positions desired for fixing curtain rod brackets to complete the installation of a curtain at reduced labor and time cost.

To achieve the above and other objects, the mounting aid for installing curtain rod brackets according to the present invention includes a main body being provided at two opposite ends with correspondingly arranged marking holes.

With the mounting aid, a user can easily utilizes the marking holes to put marks on a wall at desired positions for fixing curtain rod brackets, so that subsequent steps of fixing brackets and assembling the curtain rod can be quickly executed to complete the installation of a curtain at reduced labor and time cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a mounting aid for installing curtain rod brackets according to an embodiment of the present invention;

FIG. 2 shows the use of the mounting aid of the present invention to mark positions on a wall for installing curtain rod brackets; and

FIG. 3 shows the installation of curtain rod brackets to the positions marked on the wall using the mounting aid of the present invention.

### DETAILED DESCRIPTION OF THE PREFERRED EMBODIMENTS

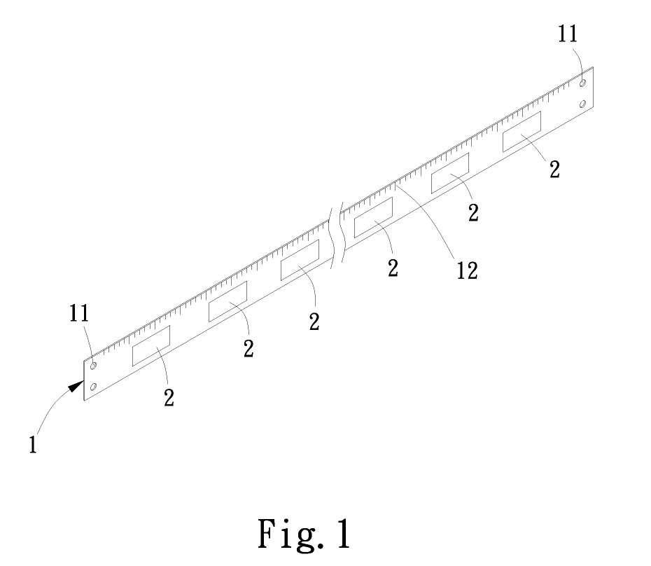

Please refer to FIG. 1 that is a perspective view of a mounting aid for installing curtain rod brackets according to an embodiment of the present invention. As shown, the mounting aid includes a main body 1.

The main body 1 of the mounting aid is provided at two opposite ends with correspondingly arranged marking holes 11. The main body 1 can be made of a material selected from the group consisting of paper, wood, plastics and metal, and is an elastic strip with flexibility. The main body 1 is provided along at least one longitudinal edge with a scale zone 12, and has a length that may be changed to meet different curtain rod lengths. Preferably, the main body 1 has a length ranged between 30.5 cm and 508 cm, a width ranged between 0.5 cm and 10 cm, and a thickness ranged between 0.01 cm and 0.2 cm. According to a preferred embodiment of the present invention, the main body 1 has a length ranged between 30.5 cm and 391 cm, a width ranged between 5 cm and 8 cm, and a thickness ranged between 0.05 cm and 0.1 cm.

The main body 1 is provided on at least one face with a plurality of instruction zones 2. The instruction zones 2 can show words, figures, or a combination of words and figures to provide instructions about the steps of installing curtain rod brackets.

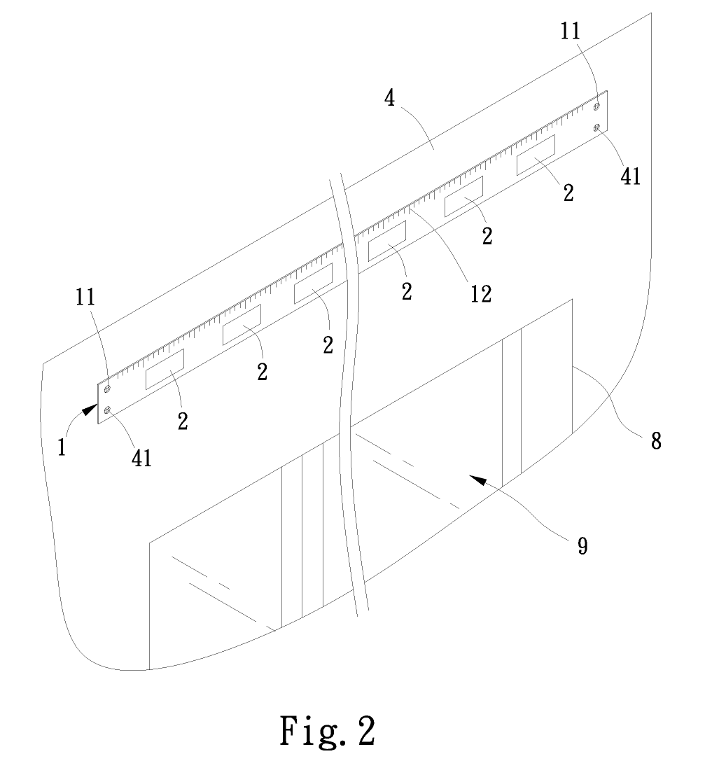

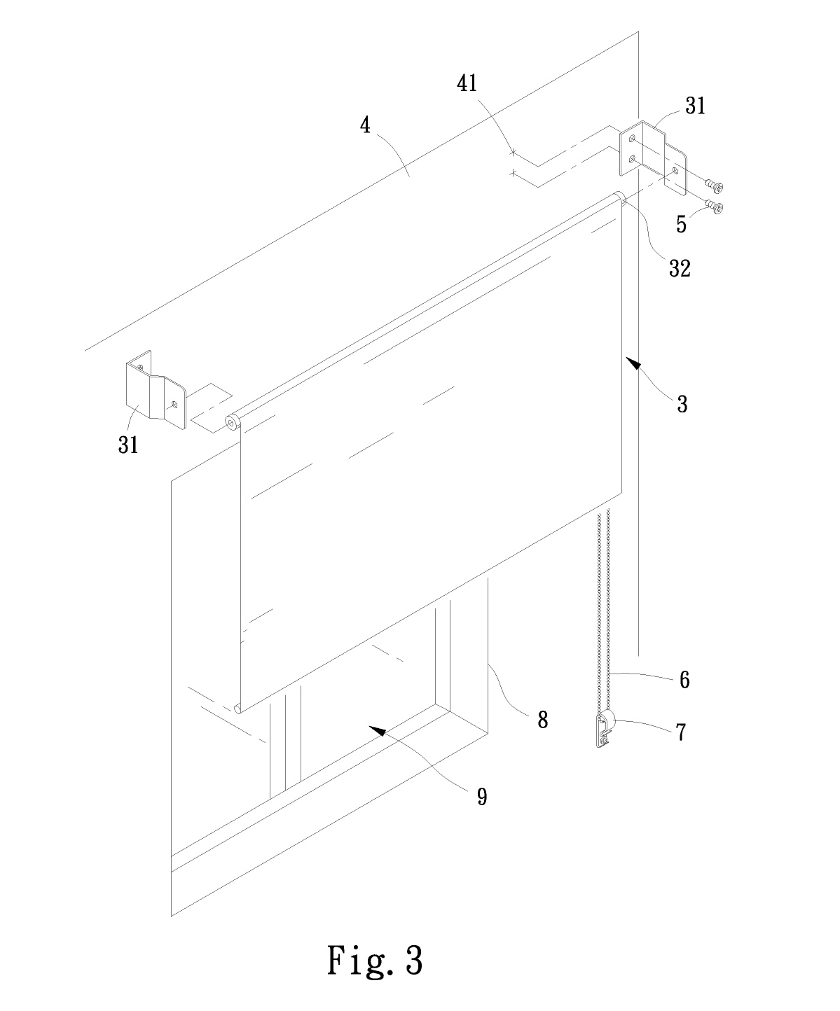

FIG. 2 shows the use of the mounting aid of the present invention to mark positions on a wall 4 for installing curtain rod brackets 31, and FIG. 3 shows the installation of the curtain rod brackets 31 to the marked positions 41 on the wall 4. As shown, when a horizontal position on the wall 4 desired for installing a rod 32 of a curtain 3 is determined, a user can bear the main body 1 of the mounting aid of the present invention on the wall 4 at the horizontal position determined for installing the curtain 3, and uses a pen to put a mark 41 on the wall 4 in each of the marking holes 11 provided on the main body 1. The main body 1 is removed when all the required marks 41 have been made. At this point, the curtain rod brackets 31 can be aligned with and fixed to the marks 41 by threading a screw 5 against each of the marks 41 into the wall 4. Finally, the rod 32 for the curtain 3 is assembled to and between the fixed curtain rod brackets 31 to complete the installation of the curtain 3 over a window frame 8. The properly installed curtain 3 can block light from projecting through a window 9 in the window frame 8, and can be lifted or lowered to a desired height by pulling a bead chain or a pull cord 6 held in place on the wall 4 via a fixing device 7, so as to control the light-screening area provided by the curtain 3. The user can also utilizes the scale zone 12 provided on the main body 1 to measure and determine other related positions for installing the curtain 3. The instruction zones 2 allow the user to clearly view the steps for installing the curtain 3, so as to quickly find and put marks on the desired positions for mounting the curtain rod brackets 31. Therefore, the mounting aid for installing curtain rod brackets according to the present invention is easy to use to save the time and labor cost of installing a curtain.

The mounting aid of the present invention is novel and improved because it includes marking holes to allow a user to put marks on the wall at positions desired for fixing the curtain rod brackets, so that the user can easily complete subsequent steps for fixing the brackets, assembling the curtain rod, etc. without consuming a lot of labor and time. Since the product derived from the present invention requires only low cost and would no doubt meet the market demands, the present invention is industrially valuable.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A mounting aid for installing curtain rod brackets, comprising a main body being provided at two opposite ends with correspondingly arranged marking holes.

2. The mounting aid for installing curtain rod brackets as claimed in claim 1, wherein the main body is made of a material selected from the group consisting of paper, wood, plastics, and metal.

3. The mounting aid for installing curtain rod brackets as claimed in claim 1, wherein the main body is provided along at least one longitudinal edge with a scale zone.

4. The mounting aid for installing curtain rod brackets as claimed in claim 1, wherein the main body is printed on at least one face a plurality of instruction zones.

5. The mounting aid for installing curtain rod brackets as claimed in claim 1, wherein the main body has a length ranged between 30.5 cm and 508 cm, a width ranged between 0.5 cm and 10 cm, and a thickness ranged between 0.01 cm and 0.2 cm.

6. The mounting aid for installing curtain rod brackets as claimed in claim 1, wherein the main body preferably has a length ranged between 30.5 cm and 391 cm, a width ranged between 5 cm and 8 cm, and a thickness ranged between 0.05 cm and 0.1 cm.

7. The mounting aid for installing curtain rod brackets as claimed in claim 2, wherein the main body is an elastic strip with flexibility.

8. The mounting aid for installing curtain rod brackets as claimed in claim 4, wherein the instruction zones show words, figures, or a combination of words and figures.
